(19) United States
(12) Patent Application Publication
(10) Pub. No.: US 2004/0172514 A1
(43) Pub. Date: Sep. 2, 2004

(54) PROCESSOR HAVING AN UNSHARED STACK MEMORY

(76) Inventors: Li-Chun Tu, Taipei City (TW); Ping-Sheng Chen, Chia-Yi Hsien (TW); Pao-Ching Tseng, Taipei City (TW); Hung-Cheng Kuo, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,716

(22) Filed: Oct. 21, 2003

(30) Foreign Application Priority Data
Feb. 27, 2003 (TW) 092104325

(51) Int. Cl. G06F 12/00

(52) U.S. Cl. 711/170; 712/202; 711/200

(57) ABSTRACT

A processor includes a CPU, a data memory, a stack memory, a memory address generator, and a stack pointer generator. The CPU is used to process data and instructions. The data memory is used to store non-stack data. The stack memory is used to store stack data. The memory address generator is used to generate addresses for accessing the data memory. The stack pointer generator is used to generate pointers for accessing the stack memory.

### BACKGROUND OF INVENTION

1. Field of the Invention

The present invention relates to a processor. In particular, the present invention discloses a processor that has an unshared stack memory.

2. Description of the Prior Art

Micro Computer System (MCS) is a series of microprocessors produced by Intel of which the MCS-31/32 and 51/52 series processors are commonly used in the manufacture of electronic devices. Generally speaking, microprocessors have relatively few memory resources and input/output ports. For example, the MCS-51 series of processors each have a 4K-byte program memory, a 128-byte data memory, and 32 input/output ports; while the MCS-52 series of processors each have an 8K-byte program memory and a 256-byte data memory. The MCS-31/32 and 51/52 series processors are both 8-bit processors, the program memory is a ROM that stores programs written by the user, and the data memory is a RAM.

FIG. 1 is a diagram of an internal data memory 12 in the MCS-51 series processor according to the prior art. The data memory 12 is shared for use as a stack memory, a data memory, and a register memory. Addresses for the stack, data, and registers are all 8 bits, and the processor processes an 8-bit command set. When accessing the internal data memory 12, 8-bit instructions and addresses are sent to a memory address generator 14 to generate memory addresses. The internal data memory in the MCS-51 series processor is 128 bytes, while the internal memory in the MCS-52 series processor is 256 bytes. An external data memory in the MCS-51/52 series processor can be extended to 64K bytes. The internal data memory 12 is divided into several segments: a) addresses 00H-1FH: a 32-byte register bank comprising four working register banks which have 8 registers each, wherein data can be accessed by direct addressing or indirect addressing; b) addresses 20H-2FH: a bit-addressing segment of 16 bytes (128 bits), wherein bits in the bit-addressing segment can be operated on via bitwise operational instructions; c) addresses 30H-7FH: a general segment for use by the user,wherein a stack is usually located by appointing stack pointers to this segment; and d) addresses 80H-FFH: a general segment existing only in the MCS-52 series processors and accessible only by indirect addressing.

FIG. 2 is a diagram of the internal data memory 12 comprising two stacks according to the prior art. The configuration of the internal data memory 12 is shown as in FIG. 2. Some of the memory is used for registers and data, and the other memory is used for the stack. As described above, the stack is usually located in the general segment of the internal data memory 12, and the stack pointer points to a position of the general segment as a stack starting address in the beginning. The stack is used to store the program counter when calling subroutines or to store other data as specified by the user. As shown in FIG. 2, the data stored in the stack is represented by the shaded area below the stack pointer, and the stack pointer moves upwards in a direction shown by the arrow when new data is pushed into the stack. However, when calling subroutines, many programs need to send parameters and use a software stack memory to store these parameters. The parameters stored in the software stack memory are shown as the shaded area above the software stack pointer in FIG. 2, and the software stack pointer moves downwards in a direction shown by the arrow when new parameters are pushed into the software stack memory. Because the two stacks share the limited memory, the user has to be aware of how many memory resources the two stacks use when programming.

As described above, the conventional MCS-51/52 series processors provide limited internal data memory 12. The stack memory, data memory, and register memory have to share the internal data memory 12. As the complexity of computer systems increases, more stack memory and data memory is needed. Although the internal data memory 12 can be extended through the use of an external data memory, the amount of stack memory is still limited by the internal data memory 12. Accordingly, the stack memory is not adequate for complicated programs need to call many subroutines. Limited stack memory requires programs to call only a limited number of subroutines. Moreover, if subroutines have to send parameters, more stack memory is needed. Because the MCS-51/52 series processors process an 8-bit command set, each of the memory addresses is 1-byte (8-bit) and the internal data memory is limited to 256-byte. Therefore, when stack memory cannot be extended, a user has to be aware of the stack size and has difficulties in programming.

### SUMMARY OF INVENTION

It is therefore a primary objective of the present invention to provide a processor with an unshared stack memory.

Briefly summarized, the present invention discloses a processor, comprising a central processing unit, a data memory, a stack memory, a memory address generator, and a stack pointer generator. The central processing unit is used to process data and instructions. The data memory stores non-stack data for functions of registers. The stack memory stores stack data. The memory address generator produces addresses for accessing the data memory. The stack pointer generator produces pointers for accessing the stack memory.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of an interior data memory in a conventional MCS-51 series processor.

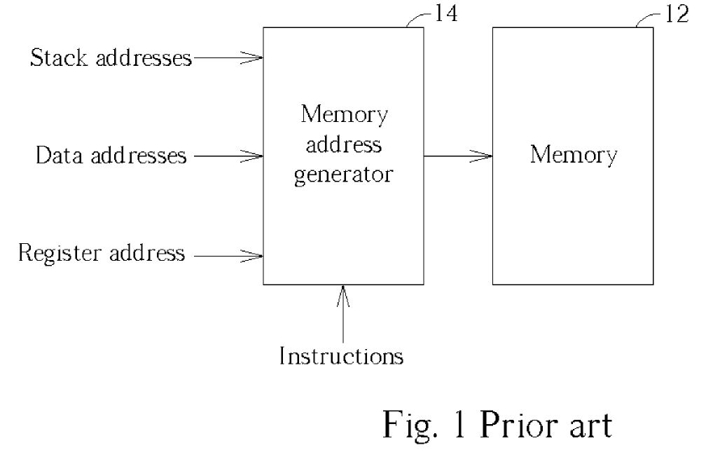

FIG. 2 is a schematic diagram of a conventional interior data memory comprising two stacks.

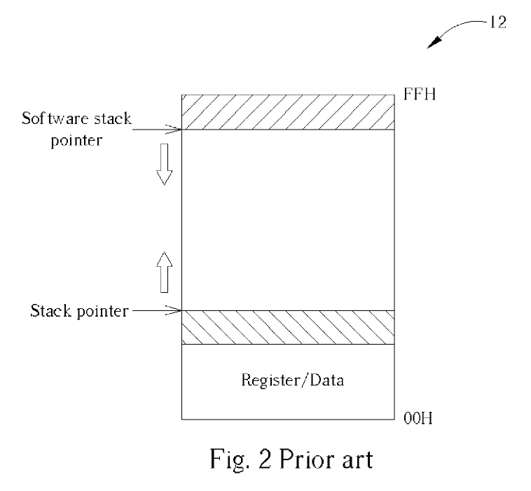

FIG. 3 is a schematic diagram of an interior memory according to the present invention.

FIG. 4 is a schematic diagram of a hardware stack and a software stack disposed in a stack memory which is depicted in FIG. 3.

### DETAILED DESCRIPTION

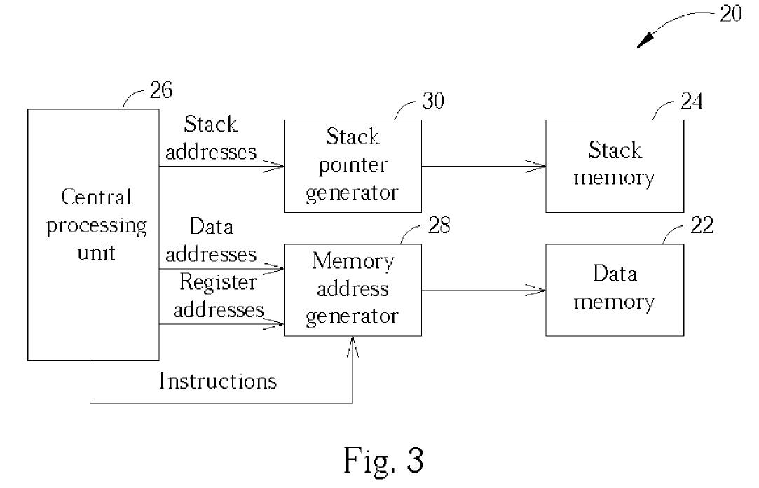

Please refer to FIG. 3. FIG. 3 is a schematic diagram of an interior memory of the present invention processor 20. The interior memory comprises a data memory 22 and a stack memory 24. A central processing unit (CPU) 26 in the processor 20 processes an 8-bit instruction set. When not changing the instruction set, the largest ranges of the CPU 26 for accessing the data memory 22 and the stack memory 24 are both 256 bytes. The data memory 22 is used to store data for executing programs, functioning as registers when the CPU 26 operates. The method of accessing data memory 22 is substantially the same as conventional method except that the data memory 22 does not store stack data; therefore, when the CPU 26 needs stack space to execute programs, stack data is stored in the stack memory 24, which is only used to store stack data. The CPU 26 uses the stack memory 24 referencing a stack pointer generator 30.

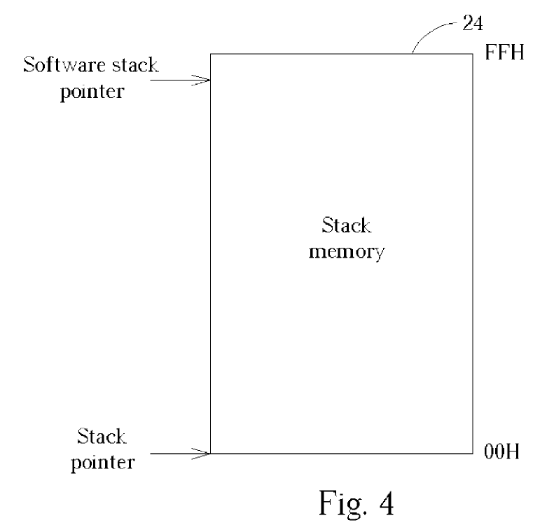

Please refer to FIG. 4. FIG. 4 is a schematic diagram of two stacks disposed in the present invention stack memory 24. Generally speaking, the hardware stack utilizes the stack pointer which starts incrementally from a predetermined position to point to a next address, while the software stack utilizes a software pointer which decreases from a predetermined position. For maximizing the stack usage, a better disposition of the stack memory 24 is to set the stack pointer to OOH as a start address of the hardware stack and to set the software stack pointer to FFH as a start address of the software stack. The stack pointer of the hardware stack starts incrementally from the lowest address of the stack memory 24 to point to a next address. The software stack pointer of the software stack decreases from the highest address of the stack memory 24. The stack pointer and the software stack pointer cannot be coincident, in other words, the largest amount of the two stacks cannot exceed the 256-byte stack memory 24. In addition, if the stack memory 24 is disposed with two stacks having the same size, the stack pointer is appointed to 80H as the start address of the hardware stack and the software stack pointer is appointed to 7FH as the start address of the software stack. Consequently, the stack pointer starts incrementally from 80H to the largest address FFH and the hardware stack is positioned in addresses 80H-FFH of the stack memory 24. The software stack pointer decreases from 7FH to the lowest address 00H and the software stack is positioned in addresses 00H-7FH of the stack memory 24. The two stacks utilize respectively half of the stack memory 24, namely 128 bytes.

Briefly summarized, the present invention processor comprises the CPU 26, the data memory 22, the stack memory 24, the memory address generator 28, and the stack pointer generator 30. When executing programs, the CPU 26 accesses the data memory 22 through the memory address generator 28 so as to read data for executing programs and write data into the data memory 22. However, when executing instructions related to stacks, the CPU 26 accesses the stack memory 24 through the stack pointer generator 30. Therefore, the stack memory 24 is used for stack data only and the data memory 22 is shared by non-stack data.

Compared with the prior art, the present invention provides the processor with an unshared stack memory, while the conventional processor just has a limited interior data memory shared by stack memory, data memory, and register memory. Although data memory can be extended through an exterior data memory, the amount of the stack memory is still limited from the interior data memory provided by the CPU. This can bring about insufficient stack memory, especially when complex programs require multiple levels of subroutines. The present invention processor has a data memory and a stack memory, and thereby enhance the system.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A processor comprising:
a central processing unit (CPU) processing data according to an instruction set;
a data memory storing non-stack data;
a stack memory storing stack data;
a memory address generator producing addresses for accessing the data memory; and
a stack pointer generator producing pointers for accessing the stack memory.

2. The processor of claim 1 wherein the processor is a Micro Computer System (MCS) series processor.

3. The processor of claim 1 wherein the processor processes an 8-bit instruction set.

4. The processor of claim 3 wherein the data memory is 256 bytes.

5. The processor of claim 3 wherein the stack memory is 256 bytes.
